(19) United States
(12) Patent Application Publication
(10) Pub. No.: US 2025/0157202 A1
(43) Pub. Date: May 15, 2025

(54) IMAGE PROCESSING METHOD, STORAGE MEDIUM AND COMPTUER DEVICE

(71) Applicant: Beijing Youzhuju Network Technology Co., Ltd., Beijing (CN)

(72) Inventors: Ya JING, Beijing (CN); Tao KONG, Beijing (CN)

(21) Appl. No.: 18/839,645

(22) PCT Filed: Aug. 10, 2023
(86) PCT No.: PCT/CN2023/112209

§ 371 Date: Aug. 19, 2024

(30) Foreign Application Priority Data
Aug. 23, 2022 (CN) 202211014186.7

(51) Int. Cl. G06V 10/778; A47L 9/28; G06V 10/764; G06V 20/58

(52) U.S. Cl. CPC G06V 10/778; A47L 9/2805; A47L 9/2852; G06V 10/764; G06V 20/58; A47L 2201/04

(57) ABSTRACT

An image processing method, a storage medium and a computer device are provided. The method includes obtaining observation information acquired by a target robot within a target observation space, wherein the observation information includes observation images, depth images, and sensor pose information; obtaining a three-dimensional semantic distribution map based on the observation information; learning an exploration policy of the target robot based on conditions of a semantic distribution inconsistency and a class distribution uncertainty according to the three-dimensional semantic distribution map; obtaining, based on at least one condition of the semantic distribution inconsistency and the class distribution uncertainty, hard sample images from the target observation images corresponding to the exploration trajectory; adjusting a perception model of the target robot based on the hard sample images.

The present application claims priority to Chinese Patent Application No. 202211014186.7, filed on Aug. 23, 2022, which is incorporated herein by reference in its entirety as a part of the present application.

### TECHNICAL FIELD

Embodiments of the present disclosure relate to an image processing method and apparatus, a storage medium, and a device.

### BACKGROUND

With the wide application of perception models in the field of robotics, the research on how to effectively generalize the perception models to real three-dimensional environments has become an important research topic. Training a robotic perception model differs from training a static perception model based on pictures acquired from the Internet in conventional computer vision in the following aspects: (1) Picture data used for training is not a fixed dataset acquired from the Internet, but needs to be acquired by moving in a virtual or real three-dimensional (3D) space. (2) The static perception model involves separate processing of each training sample, while the robotic perception model involves observation of the same object at different viewing angles during the movement of a robot in a space. (3) A method on how to effectively learn an exploration policy and acquire training samples is the key to a task of training the robotic perception model.

### SUMMARY

Embodiments of the present disclosure provide an image processing method and apparatus, a storage medium, a device, and a program product, which make it possible to measure a semantic distribution difference based on a three-dimensional semantic distribution map, and learn an exploration trajectory with reference to a semantic distribution inconsistency and a class distribution uncertainty, so as to focus on a class distribution uncertainty predicted at the same viewing angle and semantic distribution inconsistencies predicted at different viewing angles, highlight the importance of hard sample images, and finally fine-tune a perception model based on annotated hard sample images, thereby reducing the annotation cost, and improving the perception accuracy of the perception model.

According to an aspect, an embodiment of the present disclosure provides an image processing method. The method includes: obtaining observation information acquired by a target robot within a target observation space, where the observation information includes observation images, depth images, and sensor pose information; obtaining a three-dimensional semantic distribution map based on the observation information; learning an exploration policy of the target robot based on conditions of a semantic distribution inconsistency and a class distribution uncertainty according to the three-dimensional semantic distribution map; moving the target robot based on the exploration policy, to obtain an exploration trajectory of the target robot, where the exploration trajectory includes target observation images acquired by the target robot during the movement within the target observation space; obtaining, based on at least one condition of the semantic distribution inconsistency and the class distribution uncertainty, hard sample images from the target observation images corresponding to the exploration trajectory, where the hard sample images are used to represent images with inconsistent predicted semantic distribution results and/or uncertain predicted class distribution results; and adjusting a perception model of the target robot based on the hard sample images.

In some embodiments, the semantic distribution inconsistency represents that inconsistent predicted distribution results are obtained by the target robot when observing a same target object at different viewing angles during the movement; and the class distribution uncertainty represents a case where when observing a same target object at a same viewing angle during the movement of the target robot, the target robot predicts that there are a plurality of categories of the target object and two of the plurality of categories have similar predicted category probabilities and are both greater than a first preset threshold.

In some embodiments, based on the three-dimensional semantic distribution map, the observation images include a first observation image and a second observation image, the first target observation image is an observation image acquired when the same target object is observed at different viewing angles, and the second target observation image is an observation image acquired when the same target object is observed at the same viewing angle. The learning an exploration policy of the target robot based on conditions of a semantic distribution inconsistency and a class distribution uncertainty according to the three-dimensional semantic distribution map includes: obtaining, based on the first observation image, a current prediction result of when the target robot observes the same target object at different viewing angles during the movement, and calculating a first semantic distribution inconsistency reward based on the current prediction result and the three-dimensional semantic distribution map; obtaining first predicted category probabilities for all target objects in the second observation image, and calculating a first class distribution uncertainty reward based on the first predicted category probabilities for all the target objects; and learning an exploration policy of the target robot based on the first semantic distribution inconsistency reward and the first class distribution uncertainty reward.

In some embodiments, the target observation images corresponding to the exploration trajectory include first target observation images and second target observation images, the first target observation images are observation images acquired when the same target object is observed at different viewing angles, and the second target observation images are observation images acquired when the same target object is observed at the same viewing angle. The obtaining, based on at least one condition of the semantic distribution inconsistency and the class distribution uncertainty, hard sample images from the target observation images corresponding to the exploration trajectory includes:
obtaining, based on the condition of the semantic distribution inconsistency, a first hard sample image from the first target observation image corresponding to the exploration trajectory, where the first hard sample image is used to represent an image with an inconsistent predicted semantic distribution result; and/or
obtaining, based on the condition of the class distribution uncertainty, a second hard sample image from the second target observation image corresponding to the exploration trajectory, where the second hard sample image is used to represent an image with an uncertain predicted class distribution result.

In some embodiments, the obtaining, based on the condition of the class distribution uncertainty, a second hard sample image from the second target observation image corresponding to the exploration trajectory includes: obtaining a second target observation image corresponding to the exploration trajectory; calculating second predicted category probabilities for all target objects in the second target observation image corresponding to the exploration trajectory; calculating a second class distribution uncertainty based on the second predicted category probabilities for all the target objects in the second target observation image; and determining, as a second hard sample image, a corresponding image in the second target observation image corresponding to the exploration trajectory that has a second class distribution uncertainty greater than a first preset threshold.

In some embodiments, the obtaining, based on the condition of the semantic distribution inconsistency, a first hard sample image from the first target observation image corresponding to the exploration trajectory includes: obtaining a first target observation image corresponding to the exploration trajectory; obtaining, based on the first target observation image, a target prediction result of when the target robot observes the same target object at different viewing angles during the movement, and calculating a second semantic distribution inconsistency based on the target prediction result and the three-dimensional semantic distribution map; and determining, as a first hard sample image, a corresponding image in the first target observation image that has a second semantic distribution inconsistency greater than a second preset threshold.

In some embodiments, the moving the target robot based on the exploration policy, to obtain an exploration trajectory of the target robot includes: determining a direction of travel of the target robot at a next moment tᵢ₊₁ based on the exploration policy and target observation information acquired by the target robot at a current moment tᵢ, where the direction of travel is used to indicate a direction in which the target robot should move at the next moment tᵢ₊₁, the target observation information includes target observation images, target depth images, and target sensor pose information, and i≥0; and controlling the target robot to perform a movement operation based on the direction of travel, to obtain an exploration trajectory of the target robot and a target observation image at each time step on the exploration trajectory.

In some embodiments, the obtaining a three-dimensional semantic distribution map based on the observation information includes: inputting the observation images into a pre-trained perception model, to obtain semantic category prediction results for the observation images, where the semantic category prediction result is used to represent a predicted probability distribution of each pixel in the observation image among C categories, and C represents a predicted number of categories of target objects; establishing a point cloud corresponding to the target observation space based on the depth images, where each point in the point cloud corresponds to a respective one of the semantic category prediction results; transforming the point cloud into a three-dimensional space based on the sensor pose information, to obtain a voxel representation; and aggregating, based on an exponential moving average formula, the voxel representation at a same position over time, to obtain the three-dimensional semantic distribution map.

In some embodiments, the adjusting a perception model of the target robot based on the hard sample images includes: obtaining the hard sample images and semantic annotation information for the hard sample images, where the semantic annotation information includes bounding boxes for all target objects in each of the hard sample images, pixels corresponding to each of the target objects, and a category of each of the target objects; inputting the hard sample images into the pre-trained perception model, to obtain semantic category prediction results corresponding to the hard sample images; and adjusting parameters of the pre-trained perception model based on the semantic category prediction results corresponding to the hard sample images and the semantic annotation information, to obtain an adjusted perception model.

In some embodiments, before the learning an exploration policy of the target robot, the method further includes: inputting the three-dimensional semantic distribution map into a global policy network to select a long-term objective, where the long-term objective represents x-y coordinates in the three-dimensional semantic distribution map; inputting the long-term objective into a local policy network for path planning, to obtain a predicted discrete action of the target robot, where the predicted discrete action includes at least one of moving forward, turning left, and turning left; and sampling the long-term objective based on a preset number of local steps, to obtain sampled data, where the sampled data is used to learn the discrete action of the target robot.

In some embodiments, the obtaining observation information acquired by a target robot within a target observation space includes: obtaining, based on a shooting apparatus of the target robot, an observation image and a depth image corresponding to each time step within a preset time period, where the observation image is a color image, and the depth image is an image in which distance values of various points in the target observation space that are acquired by the shooting apparatus are used as pixel values; and obtaining, based on a sensor of the target robot, sensor pose information corresponding to each time step within the preset time period, where the sensor pose information includes at least pose information of three degrees of freedom.

According to another aspect, an embodiment of the present disclosure provides an image processing apparatus. The apparatus includes:
a first obtaining unit configured to obtain observation information acquired by a target robot within a target observation space, where the observation information includes observation images, depth images, and sensor pose information;
a second obtaining unit configured to obtain a three-dimensional semantic distribution map based on the observation information;
a learning unit configured to learn an exploration policy of the target robot based on conditions of a semantic distribution inconsistency and a class distribution uncertainty according to the three-dimensional semantic distribution map;
a determination unit configured to move the target robot based on the exploration policy, to obtain an exploration trajectory of the target robot, where the exploration trajectory includes target observation images acquired by the target robot during the movement within the target observation space;
a third obtaining unit configured to obtain, based on at least one condition of the semantic distribution inconsistency and the class distribution uncertainty, hard sample images from the target observation images corresponding to the exploration trajectory, where the hard sample images are used to represent images with inconsistent predicted semantic distribution results and/or uncertain predicted class distribution results; and an adjustment unit configured to adjust a perception model of the target robot based on the hard sample images.

According to another aspect, an embodiment of the present disclosure provides a computer-readable storage medium storing a computer program, where the computer program is suitable for being loaded by a processor, to perform the image processing method according to any one of the above embodiments.

According to another aspect, an embodiment of the present disclosure provides a computer device including a processor and a memory, where the memory stores a computer program, and the processor is configured to perform the image processing method according to any one of the above embodiments by invoking the computer program stored in the memory.

According to another aspect, an embodiment of the present disclosure provides a computer program product including a computer program, where when the computer program is executed by a processor, the image processing method according to any one of the above embodiments is implemented.

### BRIEF DESCRIPTION OF DRAWINGS

In order to describe the technical solutions in the embodiments of the present disclosure more clearly, the accompanying drawings for describing the embodiments are briefly described below. Apparently, the accompanying drawings in the following description are merely some embodiments of the present disclosure, and those skilled in the art may derive other accompanying drawings from these accompanying drawings without creative efforts.

FIG. 1 is a schematic flowchart of an image processing method according to an embodiment of the present disclosure;

FIG. 2 is a schematic diagram of an application scenario of an image processing method according to an embodiment of the present disclosure;

FIG. 3 is a schematic diagram of a structure of an image processing apparatus according to an embodiment of the present disclosure; and

FIG. 4 is a schematic diagram of a structure of a computer device according to an embodiment of the present disclosure.

### DETAILED DESCRIPTION

The technical solutions in the embodiments of the present disclosure are clearly and completely described below with reference to the drawings of the embodiments of the present disclosure. However, apparently, the embodiments described are merely some embodiments of the present disclosure rather than all the embodiments. All the other embodiments obtained by those of ordinary skill in the art based on the embodiments of the present disclosure without any creative effort shall fall within the scope of protection of the present disclosure.

The embodiments of the present disclosure provide an image processing method and apparatus, a computer-readable storage medium, a computer device, and a computer program product. Specifically, the image processing method in the embodiment of the present disclosure may be directly applied in a robot, a server, or a system including a terminal and a server, and is implemented through interaction between the terminal and the server. In the embodiment of the present disclosure, the robot refers to a robot that needs to move in a space, and observation information acquired by a target robot within a target observation space needs to be obtained, where the observation information includes observation images, depth images, and sensor pose information; a three-dimensional semantic distribution map is obtained based on the observation information; next, an exploration trajectory of the target robot is learned based on conditions of a semantic distribution inconsistency and a class distribution uncertainty according to the three-dimensional semantic distribution map; then, hard sample images are obtained from target observation images corresponding to the exploration trajectory based on the condition of the class distribution uncertainty, where the hard sample images are used to represent images with uncertain predicted class distribution results; and a perception model of the robot is adjusted based on the hard sample images. The specific type and model of the robot are not limited in this embodiment. The server may be implemented as a standalone server or a server cluster of a plurality of servers.

They are respectively described in detail below. It should be noted that the order of description of the following embodiments does not constitute a limitation on the order of precedence for the embodiments.

Each embodiment of the present disclosure provides an image processing method. The method may be performed by a robot or a server, or by both the robot and the server. In the embodiment of the present disclosure, description is made by using an example in which the image processing method is performed by the robot (a computer device).

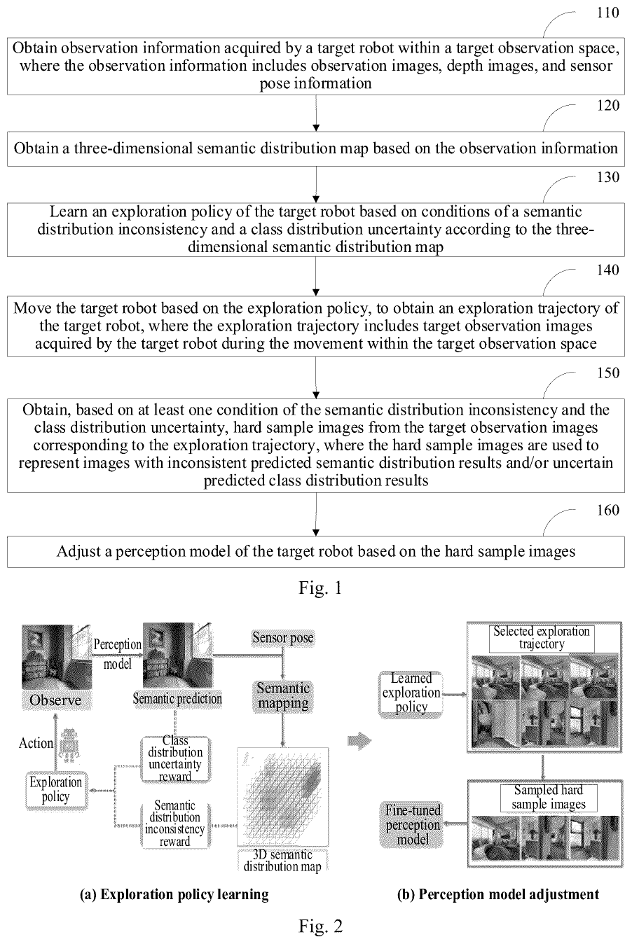

Referring to FIG. 1 and FIG. 2, FIG. 1 is a schematic flowchart of an image processing method according to an embodiment of the present disclosure, and FIG. 2 is a schematic diagram of an application scenario according to an embodiment of the present disclosure. The method is implemented through the steps 110 to 150, which are specifically as follows.

Step 110: Obtain observation information acquired by a target robot within a target observation space, where the observation information includes observation images, depth images, and sensor pose information.

Specifically, the observation information acquired by the target robot during movement within the target observation space is obtained, where the observation information includes the observation images, the depth images, and the sensor pose information.

For example, the target observation space may be an observation space that is close to a real environment where the target robot is applied. For example, the target robot is a mobile robot, and is distinguished depending on an application scenario. If the target robot is a household robot (e.g., a robot vacuum cleaner), the target observation space is an indoor home environment or an indoor office environment. For example, if the target robot is a logistics robot (e.g., a cargo handling robot), the target observation space is a real environment with a logistics channel.

For example, at each time step, the observation information acquired by the target robot within the target observation space includes one RGB observation image IₜϵR^{3×W}^{_{I}}^{×H}^{_{I}}, one depth image DₜϵR^{3×W}^{_{I}}^{×H}^{_{I}}, and one three-degree-of-freedom sensor pose xₜϵR³. The three-degree-of-freedom sensor pose is used to represent x-y coordinates and a robot direction.

The robot has three discrete actions: moving forward, turning left, and turning right. The three discrete actions may correspond to the x-y coordinates and the robot direction. For example, when a current robot orientation indicates moving forward, coordinates and a robot direction after movement may be calculated based on a distance of one step by which the robot moves. For example, when the current robot orientation indicates moving forward, the robot direction remains unchanged.

In some embodiments, the obtaining observation information acquired by a target robot within a target observation space includes:
obtaining, based on a shooting apparatus of the target robot, an observation image and a depth image corresponding to each time step within a preset time period, where the observation image is a color image, and the depth image is an image in which distance values of various points in the target observation space that are acquired by the shooting apparatus are used as pixel values; and
obtaining, based on a sensor of the target robot, sensor pose information corresponding to each time step within the preset time period, where the sensor pose information includes at least pose information of three degrees of freedom.

For example, the shooting apparatus may be an apparatus that is mounted on the target robot and used to acquire images of a surrounding environment. The shooting apparatus performs continuous shooting to obtain consecutive frames of images of the surrounding environment, and the image of the surrounding environment may include a RGB observation image and a depth image. For example, the shooting apparatus may be an RGBD camera. The RGBD camera is a camera based on structured light technology, and typically has two camera lenses, namely, one RGB camera lens for acquiring the RGB observation image, and one IR camera lens for acquiring an infrared image, where the infrared image may serve as the depth image.

For example, the pose information of three degrees of freedom may be obtained based on a three-degree-of-freedom sensor mounted on the target robot.

Step 120: Obtain a three-dimensional semantic distribution map based on the observation information.

In some embodiments, the obtaining a three-dimensional semantic distribution map based on the observation information includes:
inputting the observation images into a pre-trained perception model, to obtain semantic category prediction results for the observation images, where the semantic category prediction result is used to represent a predicted probability distribution of each pixel in the observation image among C categories, and C represents a predicted number of categories of target objects;
establishing a point cloud corresponding to the target observation space based on the depth images, where each point in the point cloud corresponds to a respective one of the semantic category prediction results;
transforming the point cloud into a three-dimensional space based on the sensor pose information, to obtain a voxel representation; and
aggregating, based on an exponential moving average formula, the voxel representation at a same position over time, to obtain the three-dimensional semantic distribution map.

In this embodiment of the present disclosure, the three-dimensional (3D) semantic distribution map may be used to fuse semantic predictions for different frames during the movement of the target robot. As shown in FIG. 2, FIG. 2 shows a semantic mapping process for one time step on the left side.

First, for an observed observation image It, a pre-trained perception model (e.g., Mask RCNN) is used to perform a semantic prediction to predict a semantic category of an object observed in the observation image, to obtain a semantic category prediction result for the observation image, where the semantic category prediction result represents a predicted probability distribution of each pixel in the observation image among C categories.

For example, the pre-trained perception model may be a Mask R-CNN model. Mask R-CNN is an instance segmentation algorithm, which mainly focuses on segmentation targets of objects on the basis of target detection. For example, the observation image is input into the pre-trained perception model, and the obtained semantic category prediction result for the observation image includes bounding boxes for all target objects in the observation image, pixels (segmentation masks) corresponding to each target object, and a category of each target object. For example, the target object may be an object to be observed in the target observation space. For example, all the target objects in the observation image may include a chair, a couch, a potted plant, a bed, a toilet, and a TV, and therefore pixels (segmentation masks) corresponding to each target object represent: which pixels in the observation image belong to the chair, which pixels in the observation image belong to the couch, which pixels in the observation image belong to the potted plant, which pixels in the observation image belong to the bed, which pixels in the observation image belong to the toilet, and which pixels in the observation image belong to the TV.

Then, a depth image Dt is used to calculate the point cloud through mathematical transformation, where each point in the point cloud corresponds to a respective semantic category prediction result.

Depth image: Also known as a range image, it is an image in which distance (depth) values from an image acquisition device (the shooting apparatus) to various points in a scenario (the target observation space) are used as pixel values. Methods for obtaining a depth image include: laser radar-based depth imaging, computer stereo vision-based imaging, a coordinate measuring machine, moire fringes, structured light, etc.

Point cloud: When a laser beam irradiates a surface of an object, reflected laser light may carry information such as an orientation and a distance. If the laser beam performs scanning according to a certain trajectory, information of reflected laser points may be recorded during scanning. Due to the extremely fine scanning, a large number of laser points can be obtained, thereby forming a laser point cloud. Point cloud formats include *.las, *.pcd, *.txt, etc.

The depth image may be calculated as point cloud data through coordinate transformation; and point cloud data with rules and necessary information may also be inversely calculated as the depth image.

In some embodiments, transforming the depth image into the point cloud may be transformation of coordinate systems: transforming an image coordinate system into a world coordinate system. Constraint conditions for the transformation are camera intrinsic parameters, and a transformation formula is as follows:

$$[ \begin{matrix}x \\ y \\ z\end{matrix} ] = D [ \begin{matrix}\frac{1}{{f}_{x}} & 0 & 0 \\ 0 & \frac{1}{{f}_{y}} & 0 \\ 0 & 0 & 1\end{matrix} ] [ \begin{matrix}{x}^{′} \\ {y}^{′} \\ 1\end{matrix} ] ,$$

where (x, y, z) represents a point cloud coordinate system, (x′, y′) represents the image coordinate system, and D represents a depth value.

There are generally four camera intrinsic parameters: fx, fy, u0, and v0, where fx=F/dx, and fy=F/dy, F representing a focal length; dx and dy represent: length units occupied by one pixel in an x direction and a y direction, respectively, that is, the magnitude of an actual physical value represented by one pixel, and dx and dy are the key to implement the transformation between an image physical coordinate system and a pixel coordinate system; and u0 and v0 represent: a difference in a number of horizontal and vertical pixels between center pixel coordinates of the image and origin pixel coordinates of the image. Theoretical values should be half of a width of the image and half of a height of the image. For a better camera lens, u0 and v0 are closer to half of a resolution.

For example, before the above transformation is performed, a distortion correction function (undistort) operation may be performed on (x′, y′) to correct distortion. A camera imaging process is actually a process of converting points from the world coordinate system to a camera coordinate system, then projecting them to obtain the image coordinate system, and further transforming same into the pixel coordinate system. However, due to the lens accuracy and process, distortion may be introduced (the distortion means that a straight line in the world coordinate system is transformed into another coordinate system that is no longer a straight line), leading to image distortion. To solve this problem, a camera distortion correction model is introduced.

Then, based on a differentiable geometric transformation of the sensor pose information, the point cloud is transformed into a 3D space to obtain a voxel representation mₜϵR^{C×L}^{ₘ}^{×W}^{ₘ}^{×H}^{ₘ}, where L, W, and H represent a length, a width, and a height, respectively.

For example, a plurality of depth images used to construct a point cloud may be depth images acquired by the target robot based on different viewing angles. Therefore, a coordinate system of the point cloud may be different from a coordinate system of the target observation space (the 3D space). For example, a reference coordinate system of the target observation space may be represented by the world coordinate system (a Cartesian coordinate system). Therefore, it is necessary to transform the point cloud obtained through the depth images into the reference coordinate system of the target observation space. The sensor pose information may include a position and a pose, corresponding to displacement and rotation. There are generally two coordinate systems: one is the world coordinate system (the Cartesian coordinate system) used for reference, and the other is a rigid body coordinate system with a center of mass of a rigid body (e.g., a robot) as an origin. Mapping represents the coordinate transformation of the same point between different coordinate systems. The mapping includes translation and rotation. The translation is related to a position of the origin of the rigid body coordinate system, and the rotation is related to a pose of the rigid body coordinate system. In this embodiment of the present disclosure, the rigid body coordinate system corresponding to the point cloud may be determined based on the differentiable geometric transformation of the sensor pose information, and is then transformed into the world coordinate system, to obtain the voxel representation.

Then, the voxel representation at the same position over time is aggregated using the exponential moving average formula, to obtain the 3D semantic distribution map Mₜ:

$${M}_{t} = {M}_{t - 1} , t = 1 ; and$$

$${M}_{t} = λ * {M}_{t - 1} + ( 1 - λ ) * {m}_{t} , t > 1 ,$$

where the 3D semantic distribution map is initialized with all zeros at the beginning. λ is a hyperparameter used to control a proportion between a currently predicted voxel representation mt and a 3D semantic distribution map Mt−1 obtained in the previous step. For example, λ may be set to 0.3.

Step 130: Learn an exploration policy of the target robot based on conditions of a semantic distribution inconsistency and a class distribution uncertainty according to the three-dimensional semantic distribution map.

For example, the 3D semantic distribution map may be used to calculate a semantic distribution inconsistency reward.

In some embodiments, the semantic distribution inconsistency represents that inconsistent predicted distribution results are obtained by the target robot when observing a same target object at different viewing angles during the movement; and the class distribution uncertainty represents a case where when observing a same target object at a same viewing angle during the movement of the target robot, the target robot predicts that there are a plurality of categories of the target object and two of the plurality of categories have similar predicted category probabilities and are both greater than a first preset threshold.

For example, the categories may be divided into six types, namely, a chair, a couch, a potted plant, a bed, a toilet, and a TV.

For example, with the TV as an example of the target object, for the semantic distribution inconsistency, when the target object is observed at different viewing angles, such as when the target object is observed from the front, the probability that the target object is predicted as the TV is 0.6, the probability that the target object is predicted as the chair is 0.2, the probability that the target object is predicted as the couch is 0.1, the probability that the target object is predicted as the potted plant is 0.05, the probability that the target object is predicted as the bed is 0.02, and the probability that the target object is predicted as the toilet is 0.03; and such as when the target object is observed from the side: the probability that the target object is predicted as the TV is 0.2, the probability that the target object is predicted as the chair is 0.1, the probability that the target object is predicted as the couch is 0.5, the probability that the target object is predicted as the potted plant is 0.15, the probability that the target object is predicted as the bed is 0.02, and the probability that the target object is predicted as the toilet is 0.03. It can be learned that the semantic distribution inconsistency occurs between the probability that the target object is predicted as the TV when the target object is observed from the front and the probability that the target object is predicted as the TV when the target object is observed from the side.

For example, with the TV as an example of the target object, the first preset threshold is 0.3, and for the class distribution uncertainty, when the target object is observed at the same viewing angle, the probability that the target object is predicted as the TV is 0.4, the probability that the target object is predicted as the chair is 0.35, the probability that the target object is predicted as the couch is 0.15, the probability that the target object is predicted as the potted plant is 0.05, the probability that the target object is predicted as the bed is 0.02, and the probability that the target object is predicted as the toilet is 0.03. It can be learned that the probability (0.4) that the target object is predicted as the TV is closer to the probability (0.35) that the target object is predicted as the chair, and the probability (0.4) that the target object is predicted as the TV is greater than the first preset threshold (0.3), and the probability (0.35) that the target object is predicted as the chair is greater than the first preset threshold (0.3), indicating that two categories (the TV and the chair) have higher and closer prediction probabilities in a predicted distribution result. Therefore, it is determined that the class distribution uncertainty occurs in the predicted distribution results.

In some embodiments, the observation images include a first observation image and a second observation image, the first target observation image is an observation image acquired when the same target object is observed at different viewing angles, and the second target observation image is an observation image acquired when the same target object is observed at the same viewing angle. The learning an exploration policy of the target robot based on conditions of a semantic distribution inconsistency and a class distribution uncertainty according to the three-dimensional semantic distribution map includes:
obtaining, based on the first observation image, a current prediction result of when the target robot observes the same target object at different viewing angles during the movement, and calculating a semantic distribution inconsistency reward based on the current prediction result and the three-dimensional semantic distribution map; obtaining first predicted category probabilities for all target objects in the second observation image, and calculating a first class distribution uncertainty reward based on the first predicted category probabilities for all the target objects; and learning an exploration policy of the target robot based on the first semantic distribution inconsistency reward and the first class distribution uncertainty reward.

As shown in FIG. 2, this embodiment of the present disclosure provides two new distribution-based reward methods. The exploration policy aₜ=π(Iₜ, θ) is trained by maximizing the semantic distribution inconsistency and the class distribution uncertainty obtained by the target robot during the movement, where π represents a policy network to be trained, Iₜ represents the observation image, and θ represents parameters of the policy network. The exploration policy may be used to determine the exploration trajectory of the target robot. That is, the 3D semantic distribution map is used to learn the exploration policy of the target robot in a self-supervised manner based on the semantic distribution inconsistency and the class distribution uncertainty. The objective of maximizing the semantic distribution inconsistency and the class distribution uncertainty obtained by the target robot during the movement is to expect that images in the exploration trajectory that are determined based on the learned exploration policy have a higher semantic distribution inconsistency and a higher class distribution uncertainty.

A first semantic distribution inconsistency reward r may be calculated based on the 3D semantic distribution map and the first observation images corresponding to different viewing angles; a first class distribution uncertainty reward u may be calculated based on a first predicted class probability for an i^{th} target object of all target objects in a single frame of second observation image corresponding to the same viewing angle; then, based on a sum of the first semantic distribution inconsistency reward r and the first class distribution uncertainty reward u, a target reward is obtained, namely, reward=r+u; and a reinforcement learning PPO algorithm is used to train the exploration policy, where at =π(Iₜ, θ), θ<−PPO[reward, π(θ)], and PPO represents the reinforcement learning PPO algorithm.

The first semantic distribution inconsistency reward is defined as a Kullback-Leibler divergence between the current prediction result corresponding to the first observation image and the 3D semantic distribution map. The first semantic distribution inconsistency reward encourages the target robot to explore not only a new target object, but also an object with different predicted distribution results across viewing angles: r=KL(mₜ, Mₜ₋₁), where r represents the first semantic distribution inconsistency reward, mₜ represents the currently predicted voxel representation corresponding to the first observation image, and Mₜ₋₁ represents the 3D semantic distribution map obtained in the previous step.

The KL divergence may be used to measure a degree of difference between two distributions. A smaller degree of difference between the two distributions indicates a smaller KL divergence, and vice versa. When the two distributions are consistent with each other, the KL divergence is 0.

The first class distribution uncertainty reward is used to explore target objects in the second observation image that are predicted to have a plurality of categories, where two of the plurality of categories have closer confidence levels. The first class distribution uncertainty reward satisfies u=SECmax(Pi), where Pi represents a first predicted category probability for an i^{th} target object in a single frame of second observation image, and SECmax represents the second maximum value in {pᵢ⁰, pᵢ¹, . . . , pᵢ^{C-1}}. If u is greater than a first preset threshold δ, it is considered that the predicted class distribution result is uncertain. For example, the first preset threshold δ may be set to 0.1. Alternatively, the first preset threshold δ may be set to 0.3.

In some embodiments, before the learning an exploration policy of the target robot, the method further includes:
inputting the three-dimensional semantic distribution map into a global policy network to select a long-term objective, where the long-term objective represents x-y coordinates in the three-dimensional semantic distribution map;
inputting the long-term objective into a local policy network for path planning, to obtain a predicted discrete action of the target robot, where the predicted discrete action includes at least one of moving forward, turning left, and turning left; and sampling the long-term objective based on a preset number of local steps, to obtain sampled data, where the sampled data is used to learn the discrete action of the target robot.

For example, the policy network may be divided into two parts: one is called the global policy network, which is used to predict possible x-y coordinates; and the other is called the local policy network, which uses a fast marching method for path planning, to predict a predicted discrete action of the target robot based on coordinates. To train the exploration policy, the 3D semantic distribution map is first input into the global policy network to select the long-term objective, and the long-term objective represents the x-y coordinates in the 3D semantic distribution map. Then, the long-term objective is input into the local policy network for path planning, to obtain the predicted discrete action of the target robot, where the predicted discrete action includes at least one of moving forward, turning left, and turning left. The local policy network is the fast marching method, and the fast marching method is used for path planning. This method uses a low-dimensional navigation action to achieve the objective. Based on the coordinates of the long-term objective, it is predicted whether the predicted discrete action of the target object is moving forward, turning left, or turning right. For example, a preset number is 25, and the long-term objective is sampled with every 25 local steps, to shorten a time range of reinforcement learning exploration, thereby obtaining sampled data. The sampled data is used to be input into the policy network during the training of the exploration policy, to learn the discrete action of the target object, and then learn the exploration trajectory based on the learned discrete action of the target robot.

For example, the long-term objective (the x-y coordinates) predicted by the global policy network is input into the local policy network (such as a fast marching method network) for path planning, to obtain the predicted discrete action (one of moving forward, turning left, and turning right) of the target robot. After taking one step, a predicted discrete action (one of moving forward, turning left, and turning right) of the target robot corresponding to a next step is further predicted until the 25^{th} step is taken. Then, the global policy network is updated, and a new long-term objective (x-y coordinates) is predicted and then used to predict a predicted discrete action of the target robot corresponding to a next round of 25 local steps.

Step 140: Move the target robot based on the exploration policy, to obtain an exploration trajectory of the target robot, where the exploration trajectory includes target observation images acquired by the target robot during the movement within the target observation space.

In some embodiments, the moving the target robot based on the exploration policy, to obtain an exploration trajectory of the target robot includes:
determining a direction of travel of the target robot at a next moment tᵢ₊₁ based on the exploration policy and target observation information acquired by the target robot at a current moment tᵢ, where the direction of travel is used to indicate a direction in which the target robot should move at the next moment tᵢ₊₁, the target observation information includes target observation images, target depth images, and target sensor pose information, and i≥0; and
controlling the target robot to perform a movement operation based on the direction of travel, to obtain an exploration trajectory of the target robot and a target observation image at each time step on the exploration trajectory.

For example, after the exploration policy is learned based on the semantic distribution inconsistency and the class distribution uncertainty, more samples with the semantic distribution inconsistency and more samples with the class distribution uncertainty may appear in the exploration trajectory obtained by moving the robot under the guidance of the learned exploration policy.

For example, after the exploration policy is learned, the policy network can directly output a direction of travel of the target robot at a moment t₁ based on the learned exploration policy and according to target observation information of the target robot at a start point corresponding to a moment to, where the target observation information includes a target observation image, a target depth image, and target sensor pose information, and the direction of travel represents a direction in which the target robot should move at the moment t₁. After the target robot is controlled to perform the movement operation based on the direction of travel at the moment tᵢ, a direction of travel of the target robot at a next moment tᵢ₊₁ is further output, by using the policy network, based on the learned exploration policy and target observation information acquired at a position at the current moment tᵢ, and the target robot is controlled to perform the movement operation based on the direction of travel at the next moment tᵢ₊₁. Through the above operations, an exploration trajectory representing a movement path of the target robot and a target observation image at each time step on the exploration trajectory are obtained.

For example, when the target observation image on the exploration trajectory is acquired, the second target observation image corresponding to the same viewing angle needs to be stored, and the first target observation images corresponding to different viewing angles within the entire target observation space also need to be stored.

Step 150: Obtain, based on at least one condition of the semantic distribution inconsistency and the class distribution uncertainty, hard sample images from the target observation images corresponding to the exploration trajectory, where the hard sample images are used to represent images with inconsistent predicted semantic distribution results and/or uncertain predicted class distribution results.

In some embodiments, the target observation images corresponding to the exploration trajectory include first target observation images and second target observation images, the first target observation images are observation images acquired when the same target object is observed at different viewing angles, and the second target observation images are observation images acquired when the same target object is observed at the same viewing angle.

The obtaining, based on at least one condition of the semantic distribution inconsistency and the class distribution uncertainty, hard sample images from the target observation images corresponding to the exploration trajectory includes:
obtaining, based on the condition of the semantic distribution inconsistency, a first hard sample image from the first target observation image corresponding to the exploration trajectory, where the first hard sample image is used to represent an image with an inconsistent predicted semantic distribution result; and/or
obtaining, based on the condition of the class distribution uncertainty, a second hard sample image from the second target observation image corresponding to the exploration trajectory, where the second hard sample image is used to represent an image with an uncertain predicted class distribution result.

In some embodiments, the obtaining, based on the condition of the class distribution uncertainty, a second hard sample image from the second target observation image corresponding to the exploration trajectory includes:
obtaining a second target observation image corresponding to the exploration trajectory;
calculating second predicted category probabilities for all target objects in the second target observation image corresponding to the exploration trajectory;
calculating a second class distribution uncertainty based on the second predicted category probabilities for all the target objects in the second target observation image; and
determining, as a second hard sample image, a corresponding image in the second target observation image that has a second class distribution uncertainty greater than a first preset threshold.

Exemplarily, the second predicted category probabilities are calculated for all the target objects in the second target observation image corresponding to the exploration trajectory, the second class distribution uncertainty is calculated based on the second predicted category probabilities for all the target objects, and the corresponding image in the second target observation image corresponding to the exploration trajectory that has a second class distribution uncertainty greater than the first preset threshold is determined as the second hard sample image. For example, in practical application, sampling of an image from the exploration trajectory is generally sampling a single frame of second target observation image corresponding to the same viewing angle (a single viewing angle), which allows a second hard sample image with an uncertain class distribution result to be selected by considering only a second class distribution uncertainty corresponding to the same viewing angle. In practical application, selecting the second hard sample image based on the second class distribution uncertainty corresponding to the same viewing angle is more helpful for adjusting the perception model. By focusing on the class distribution uncertainty predicted at the same viewing angle, more hard sample images may be selected.

In some embodiments, the obtaining, based on the condition of the semantic distribution inconsistency, a first hard sample image from the first target observation image corresponding to the exploration trajectory includes:
obtaining a first target observation image corresponding to the exploration trajectory;
obtaining, based on the first target observation image, a target prediction result of when the target robot observes the same target object at different viewing angles during the movement, and calculating a second semantic distribution inconsistency based on the target prediction result and the three-dimensional semantic distribution map; and
determining, as a first hard sample image, a corresponding image in the first target observation image that has a second semantic distribution inconsistency greater than a second preset threshold.

Exemplarily, if the target robot stores the exploration trajectory within the entire target observation space during the movement, the first target observation images corresponding to different viewing angles (a plurality of viewing angles) may be sampled from the exploration trajectory, and a semantic category prediction is then performed on the first target observation image, to obtain a target prediction result of when the target robot observes the same target object at different viewing angles during the movement; a second semantic distribution inconsistency is calculated based on the target prediction result and the three-dimensional semantic distribution map; and the first hard sample image with an inconsistent semantic distribution result is selected from a second target predicted image based on the second semantic distribution inconsistency. By focusing on semantic distribution inconsistencies predicted at different viewing angles, more hard sample images may be selected.

For example, if hard sample images include a first hard sample image and a second hard sample image, by focusing on the class distribution uncertainty predicted at the same viewing angle and the semantic distribution inconsistencies predicted at different viewing angles, more hard sample images may be selected, and the importance of the hard sample images may be highlighted.

Step 160: Adjust a perception model of the target robot based on the hard sample images.

In some embodiments, the adjusting a perception model of the target robot based on the hard sample images includes:
obtaining the hard sample images and semantic annotation information for the hard sample images, where the semantic annotation information includes bounding boxes for all target objects in each of the hard sample images, pixels corresponding to each of the target objects, and a category of each of the target objects;
inputting the hard sample images into the pre-trained perception model, to obtain semantic category prediction results corresponding to the hard sample images; and adjusting parameters of the pre-trained perception model based on the semantic category prediction results corresponding to the hard sample images and the semantic annotation information, to obtain an adjusted perception model.

For example, after the exploration trajectory is obtained, the simplest method is to annotate all target observation images on the exploration trajectory as sample images. However, although more objects with a semantic distribution inconsistency and a class distribution uncertainty can be found through the exploration trajectory learned by the trained exploration policy, there are still many target observation images that can be accurately identified by the pre-trained perception model. Therefore, to effectively fine-tune the perception model, the sample images that can be accurately identified by the pre-trained perception model can be ignored from all the target observation images obtained from the exploration trajectory, and then hard sample images that cannot be accurately identified by the pre-trained perception model are selected to fine-tune the perception model. For example, by calculating second semantic distribution inconsistency and/or second class distribution uncertainty, the first hard sample image with an inconsistent predicted semantic distribution result is selected based on the second semantic distribution inconsistency, and/or the second hard sample image with an uncertain predicted class distribution result is selected based on the second class distribution uncertainty, the selected first hard sample image with the inconsistent semantic distribution result and/or the selected second hard sample image with the uncertain class distribution result are/is annotated, and all the hard sample images are used to fine-tune the perception model.

Specifically, after the hard sample images are obtained, the semantic annotation information for the hard sample images is annotated. Specifically, the bounding boxes for all the target objects in each of the hard sample images, the pixels corresponding to each of the target objects, and the category of each of the target objects are annotated. Then, all the hard sample images are input into the pre-trained perception model, to obtain the semantic category prediction result corresponding to each hard sample image. Then, the parameters of the pre-trained perception model are adjusted based on the semantic category prediction result corresponding to each hard sample image and the semantic annotation information, such that the perception model outputs a semantic category prediction result for the hard sample image that is closer to the category of the target object in the annotated semantic annotation information, thereby improving the perception accuracy of the perception model, where the parameters of the perception model are parameters in Mask RCNN. Testing is performed based on a set of randomly acquired test samples, and training is stopped when an accuracy rate corresponding to the set of test samples no longer increases, so as to obtain the adjusted perception model.

As shown in Table 1 below, the method (Ours) adopted in the embodiment of the present disclosure achieves the best performance on a Matterport3D dataset compared with the related art. The performance represents the performance of AP50 on object detection (Bbox) and instance segmentation (Segm), representing the accuracy of perception. The optimal performance of AP50 is 100%.

TABLE 1

| Task | Method | Chair | Couch | Potted Plant | Bed | Toilet | Tv | Average |
|---|---|---|---|---|---|---|---|---|
| Bbox | Pre-train | 21.05 | 25.23 | 22.58 | 24.24 | 22.62 | 29.67 | 24.23 |
| | Re-train | 23.77 | 27.36 | 26.20 | 25.21 | 24.82 | 34.48 | 26.97 |
| | Random | 29.98 | 31.65 | 23.91 | 28.66 | 31.78 | 40.44 | 31.07 |
| | Active Neural SLAM [28] | 32.02 | 32.74 | 31.94 | 30.31 | 26.30 | 38.68 | 32.00 |
| | Semantic Curiosity [9] | 33.51 | 33.11 | 32.91 | 29.57 | 25.76 | 39.97 | 32.46 |
| | Ours | 33.57 | 34.36 | 32.79 | 31.54 | 28.38 | 43.81 | 34.07 |
| Segm | Pre-train | 12.72 | 22.98 | 16.71 | 23.82 | 23.85 | 29.75 | 21.64 |
| | Re-train | 14.99 | 24.68 | 18.36 | 24.32 | 25.15 | 34.23 | 23.62 |
| | Random | 18.22 | 27.25 | 8.82 | 28.19 | 29.08 | 39.39 | 25.16 |
| | Active Neural SLAM [28] | 17.89 | 29.24 | 15.22 | 29.66 | 27.29 | 38.61 | 26.32 |
| | Semantic Curiosity [9] | 18.18 | 30.06 | 18.39 | 29.03 | 26.70 | 40.01 | 27.06 |
| | Ours | 19.18 | 30.14 | 15.56 | 31.03 | 28.19 | 43.43 | 27.92 |

As shown in Table 2 below, the Table shows the performance of performing a perception prediction based on the following target objects during iterative training of the exploration policy based on the latest fine-tuned perception model: a chair, a couch, a potted plant, a bed, a toilet, a TV, etc. It can be seen from Table 2 that the performance can be further improved through the iterative training of the exploration policy based on the latest fine-tuned perception model. For example, when a number n of iterations is 1, the average performance of AP50 is 34.07%; when a number n of iterations is 2, the average performance of AP50 is 34.71%; and when a number n of iterations is 3, the average performance of AP50 is 35.03%.

TABLE 2

| Method | Chair | Couch | Potted Plant | Bed | Toilet | Tv | Average |
|---|---|---|---|---|---|---|---|
| n = 1 | 33.57 | 34.36 | 32.79 | 31.54 | 28.38 | 43.81 | 34.07 |
| n = 2 | 32.18 | 33.32 | 36.06 | 31.38 | 30.81 | 44.53 | 34.71 |
| n = 3 | 33.34 | 34.48 | 35.28 | 32.12 | 31.87 | 43.11 | 35.03 |

All of the above technical solutions may be combined in any way, to form optional embodiments of the present disclosure, and details are not described again herein.

In this embodiment of the present disclosure, the observation information acquired by the target robot within the target observation space is obtained, where the observation information includes the observation images, the depth images, and the sensor pose information; the three-dimensional semantic distribution map is obtained based on the observation information; the exploration policy of the target robot is learned based on the conditions of the semantic distribution inconsistency and the class distribution uncertainty according to three-dimensional semantic distribution map; the target robot is moved based on the exploration policy, to obtain the exploration trajectory of the target robot, where the exploration trajectory includes the target observation images acquired by the target robot during the movement within the target observation space; based on the at least one condition of the semantic distribution inconsistency and the class distribution uncertainty, the hard sample images are obtained from the target observation images corresponding to the exploration trajectory, where the hard sample images are used to represent images with inconsistent predicted semantic distribution results and/or uncertain predicted class distribution results; and the perception model of the target robot is adjusted based on the hard sample images. According to this embodiment of the present disclosure, the three-dimensional semantic distribution map is used to learn the exploration trajectory in a self-supervised manner based on the semantic distribution inconsistency and the class distribution uncertainty, the hard sample images on the learned exploration trajectory are acquired by using at least one condition of the semantic distribution inconsistency and the class distribution uncertainty, and after semantic annotation is performed on the acquired hard sample images, the perception model is fine-tuned based on the annotated hard sample images. The semantic distribution difference is measured based on the three-dimensional semantic distribution map, and the exploration trajectory is learned with reference to the semantic distribution inconsistency and the class distribution uncertainty, so as to focus on the class distribution uncertainty predicted at the same viewing angle and the semantic distribution inconsistencies predicted at different viewing angles, highlight the importance of the hard sample images, and finally fine-tune the perception model based on the annotated hard sample images. Therefore, the annotation cost is reduced, and the perception accuracy of the perception model is improved.

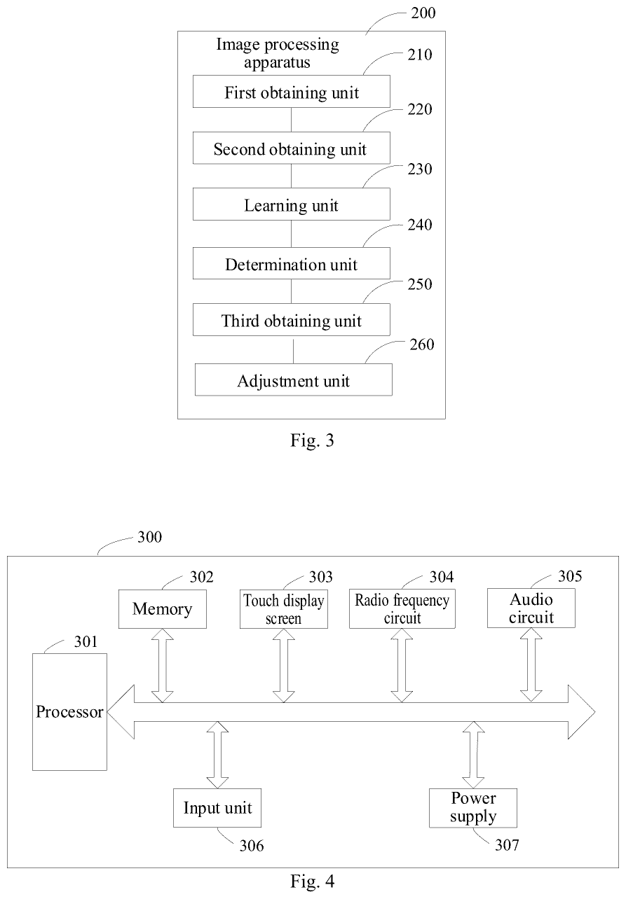

In order to better implement the image processing method in the embodiment of the present disclosure, an embodiment of the present disclosure further provides an image processing apparatus. Referring to FIG. 3, FIG. 3 is a schematic diagram of a structure of an image processing apparatus according to an embodiment of the present disclosure. The image processing apparatus 200 may include:
a first obtaining unit 210 configured to obtain observation information acquired by a target robot within a target observation space, where the observation information includes observation images, depth images, and sensor pose information;
a second obtaining unit 220 configured to obtain a three-dimensional semantic distribution map based on the observation information;
a learning unit 230 configured to learn an exploration policy of the target robot based on conditions of a semantic distribution inconsistency and a class distribution uncertainty according to the three-dimensional semantic distribution map;
a determination unit 240 configured to move the target robot based on the exploration policy, to obtain an exploration trajectory of the target robot, where the exploration trajectory includes target observation images acquired by the target robot during the movement within the target observation space;
a third obtaining unit 250 configured to obtain, based on at least one condition of the semantic distribution inconsistency and the class distribution uncertainty, hard sample images from the target observation images corresponding to the exploration trajectory, where the hard sample images are used to represent images with inconsistent predicted semantic distribution results and/or uncertain predicted class distribution results; and an adjustment unit 260 configured to adjust a perception model of the target robot based on the hard sample images.

In some embodiments, the semantic distribution inconsistency represents that inconsistent predicted distribution results are obtained by the target robot when observing a same target object at different viewing angles during the movement; and the class distribution uncertainty represents a case where when observing a same target object at a same viewing angle during the movement of the target robot, the target robot predicts that there are a plurality of categories of the target object and two of the plurality of categories have similar predicted category probabilities and are both greater than a first preset threshold.

In some embodiments, the observation images include a first observation image and a second observation image, the first target observation image is an observation image acquired when the same target object is observed at different viewing angles, and the second target observation image is an observation image acquired when the same target object is observed at the same viewing angle. The learning unit 230 is specifically configured to: obtain, based on the first observation image, a current prediction result of when the target robot observes the same target object at different viewing angles during the movement, and calculate a first semantic distribution inconsistency reward based on the current prediction result and the three-dimensional semantic distribution map; obtain first predicted category probabilities for all target objects in the second observation image, and calculate a first class distribution uncertainty reward based on the first predicted category probabilities for all the target objects; and learn an exploration policy of the target robot based on the first semantic distribution inconsistency reward and the first class distribution uncertainty reward.

In some embodiments, the target observation images corresponding to the exploration trajectory include first target observation images and second target observation images, the first target observation images are observation images acquired when the same target object is observed at different viewing angles, and the second target observation images are observation images acquired when the same target object is observed at the same viewing angle. The third obtaining unit 250 is specifically configured to:
obtain, based on the condition of the semantic distribution inconsistency, a first hard sample image from the first target observation image corresponding to the exploration trajectory, where the first hard sample image is used to represent an image with an inconsistent predicted semantic distribution result; and/or
obtain, based on the condition of the class distribution uncertainty, a second hard sample image from the second target observation image corresponding to the exploration trajectory, where the second hard sample image is used to represent an image with an uncertain predicted class distribution result.

In some embodiments, when obtaining, based on the condition of the class distribution uncertainty, a second hard sample image from the second target observation image corresponding to the exploration trajectory, the third obtaining unit 250 is specifically configured to: obtain a second target observation image corresponding to the exploration trajectory; calculate second predicted category probabilities for all target objects in the second target observation image corresponding to the exploration trajectory; calculate a second class distribution uncertainty based on the second predicted category probabilities for all the target objects in the second target observation image; and determine, as a second hard sample image, a corresponding image in the second target observation image that has a second class distribution uncertainty greater than a first preset threshold.

In some embodiments, when obtaining, based on the condition of the semantic distribution inconsistency, a first hard sample image from the first target observation image corresponding to the exploration trajectory, the third obtaining unit 250 is specifically configured to: obtain a first target observation image corresponding to the exploration trajectory; obtain, based on the first target observation image, a target prediction result of when the target robot observes the same target object at different viewing angles during the movement, and calculate a second semantic distribution inconsistency based on the target prediction result and the three-dimensional semantic distribution map; and determine, as a first hard sample image, a corresponding image in the first target observation image that has a second semantic distribution inconsistency greater than a second preset threshold.

In some embodiments, the determination unit 240 is specifically configured to: determine a direction of travel of the target robot at a next moment tᵢ₊₁ based on the exploration policy and target observation information acquired by the target robot at a current moment tᵢ, where the direction of travel is used to indicate a direction in which the target robot should move at the next moment tᵢ₊₁, the target observation information includes target observation images, target depth images, and target sensor pose information, and i≥0; and control the target robot to perform a movement operation based on the direction of travel, to obtain an exploration trajectory of the target robot and a target observation image at each time step on the exploration trajectory.

In some embodiments, the second obtaining unit 220 is specifically configured to: input the observation images into a pre-trained perception model, to obtain semantic category prediction results for the observation images, where the semantic category prediction result is used to represent a predicted probability distribution of each pixel in the observation image among C categories, and C represents a predicted number of categories of target objects; establish a point cloud corresponding to the target observation space based on the depth images, where each point in the point cloud corresponds to a respective one of the semantic category prediction results; transform the point cloud into a three-dimensional space based on the sensor pose information, to obtain a voxel representation; and aggregate, based on an exponential moving average formula, the voxel representation at a same position over time, to obtain the three-dimensional semantic distribution map.

In some embodiments, the adjustment unit 250 is specifically configured to: obtain the hard sample images and semantic annotation information for the hard sample images, where the semantic annotation information includes bounding boxes for all target objects in each of the hard sample images, pixels corresponding to each of the target objects, and a category of each of the target objects; input the hard sample images into the pre-trained perception model, to obtain semantic category prediction results corresponding to the hard sample images; and adjust parameters of the pre-trained perception model based on the semantic category prediction results corresponding to the hard sample images and the semantic annotation information, to obtain an adjusted perception model.

In some embodiments, before the learning an exploration trajectory of the target robot, the learning unit 230 is further configured to: input the three-dimensional semantic distribution map into a global policy network to select a long-term objective, where the long-term objective represents x-y coordinates in the three-dimensional semantic distribution map; input the long-term objective into a local policy network for path planning, to obtain a predicted discrete action of the target robot, where the predicted discrete action includes at least one of moving forward, turning left, and turning left; and sample the long-term objective based on a preset number of local steps, to obtain sampled data, where the sampled data is used to learn the discrete action of the target robot.

In some embodiments, the first obtaining unit 210 is specifically configured to: obtain, based on a shooting apparatus of the target robot, an observation image and a depth image corresponding to each time step within a preset time period, where the observation image is a color image, and the depth image is an image in which distance values of various points in the target observation space that are acquired by the shooting apparatus are used as pixel values; and obtain, based on a sensor of the target robot, sensor pose information corresponding to each time step within the preset time period, where the sensor pose information includes at least pose information of three degrees of freedom.

All or some of the units in the above image processing apparatus 200 may be implemented by software, hardware, and a combination thereof. The above units may be embedded in or independent of a processor in a computer device in the form of hardware, or may be stored in a memory of the computer device in the form of software, such that the processor can invoke and execute operations corresponding to the above units.

The image processing apparatus 200 may be integrated into a terminal or a server that is provided with a memory and has a computing capability with a processor mounted therein, or the image processing apparatus 200 is the terminal or the server.

In some embodiments, the present disclosure further provides a computer device including a memory and a processor, where the memory stores a computer program, and when the processor executes the computer program, the steps of the above method embodiments are implemented.

In some embodiments, the present disclosure further provides a computer device including a memory and a processor, where the memory stores a computer program, and when the processor executes the computer program, the steps of the above method embodiments are implemented.

As shown in FIG. 4, FIG. 4 is a schematic diagram of a structure of a computer device according to an embodiment of the present disclosure. The computer device may be a terminal. The computer device 300 includes a processor 301 with one or more processing cores, a memory 302 with one or more computer-readable storage media, and a computer program stored on the memory 302 and executable on the processor. The processor 301 is electrically connected to the memory 302. Those skilled in the art can understand that the structure of the computer device shown in the figure does not constitute a limitation on the computer device, and may include more or fewer components than those shown in the figure, or combine some components, or adopt different component arrangements.

The processor 301 is a control center of the computer device 300, and is connected to various parts of the whole computer device 300 by using various interfaces and lines. By running or loading a software program and/or module stored in the memory 302, and invoking data stored in the memory 302, various functions of the computer device 300 and data processing are performed, thereby performing overall processing on the computer device 300.

In this embodiment of the present disclosure, the processor 301 in the computer device 300 may load instructions corresponding to processes of one or more applications into the memory 302 according to the following steps, and the processor 301 runs the applications stored in the memory 302, to implement various functions:
obtaining observation information acquired by a target robot within a target observation space, where the observation information includes observation images, depth images, and sensor pose information; obtaining a three-dimensional semantic distribution map based on the observation information; learning an exploration policy of the target robot based on conditions of a semantic distribution inconsistency and a class distribution uncertainty according to the three-dimensional semantic distribution map; moving the target robot based on the exploration policy, to obtain an exploration trajectory of the target robot, where the exploration trajectory includes target observation images acquired by the target robot during the movement within the target observation space; obtaining, based on at least one condition of the semantic distribution inconsistency and the class distribution uncertainty, hard sample images from the target observation images corresponding to the exploration trajectory, where the hard sample images are used to represent images with inconsistent predicted semantic distribution results and/or uncertain predicted class distribution results; and adjusting a perception model of the target robot based on the hard sample images.

For the specific implementation of the above operations, reference may be made to the foregoing embodiments, which will not be repeated herein.

In some embodiments, as shown in FIG. 4, the computer device 300 further includes: a touch display screen 303, a radio frequency circuit 304, an audio circuit 305, an input unit 306, and a power supply 307. The processor 301 is electrically connected to the touch display screen 303, the radio frequency circuit 304, the audio circuit 305, the input unit 306, and the power supply 307, respectively. Those skilled in the art should understand that the structure of the computer device shown in FIG. 4 does not constitute a limitation on the computer device, and may include more or fewer components than those shown in the figure, or combine some components, or adopt different component arrangements.

The touch display screen 303 may be used to display a graphical user interface and receive an operation instruction generated by a user upon acting on the graphical user interface. The touch display screen 303 may include a display panel and a touch panel. The display panel may be used to display information input by the user or information provided to the user, as well as various graphical user interfaces of the computer device. These graphical user interfaces may be composed of graphics, text, icons, videos, and any combination thereof. In some embodiments, the display panel may be configured in the form of a liquid crystal display (LCD), an organic light-emitting diode (OLED), etc. The touch panel may be used to collect a touch operation performed by the user on or near the touch panel (e.g., an operation performed by the user on or near the touch panel by using a finger, a stylus, or any other suitable object or accessory), and generate a corresponding operation instruction, and the operation instruction executes a corresponding program. In some embodiments, the touch panel may include two parts, namely, a touch detection apparatus and a touch controller. The touch detection apparatus detects a touch orientation of the user, detects a signal generated by the touch operation, and transmits the signal to the touch controller. The touch controller receives touch information from the touch detection apparatus, converts the touch information into contact coordinates, then transmits the contact coordinates to the processor 301, and receives and executes a command sent by the processor 301. The touch panel may cover the display panel. After detecting the touch operation on or near the touch panel, the touch panel transmits the touch operation to the processor 301 to determine a type of a touch event, and the processor 301 then provides a corresponding visual output on the display panel based on the type of the touch event. In this embodiment of the present disclosure, the touch panel and the display panel may be integrated into the touch display screen 303 to implement input and output functions. However, in some embodiments, the touch panel and the touch panel may serve as two separate components to implement the input and output functions. That is, the touch display screen 303 may also serve as part of the input unit 306 to implement the input function.

The radio frequency circuit 304 may be used to receive and transmit radio frequency signals, to establish a wireless communication with a network device or other computer devices through wireless communication, thereby receiving and transmitting signals with the network device or the other computer devices.

The audio circuit 305 may be used to provide an audio interface between the user and the computer device through a speaker and a microphone. The audio circuit 305 may transmit an electrical signal, which is obtained by converting received audio data, to the speaker, which then converts the electrical signal into a sound signal for output. Moreover, the microphone converts the acquired sound signal into an electrical signal, which is received by the audio circuit 305 and converted into audio data, which is then output to the processor 301 for processing, and is then sent to, for example, another computer device via the radio frequency circuit 304, or is output to the memory 302 for further processing. The audio circuit 305 may also include an earplug jack to provide a communication between an external headphone and the computer device.

The input unit 306 may be used to receive input number and character information or object feature information (e.g., fingerprints, iris, facial information, etc.), and generate keyboard, mouse, joystick, optical, or trackball signal inputs related to user settings and function control.

The power supply 307 is used to supply power to the components of the computer device 300. In some embodiments, the power supply 307 may be logically connected to the processor 301 through a power management system, to implement functions such as charging, discharging, and power consumption management through the power management system. The power supply 307 may also include one or more of a direct-current or alternating-current power supply, a recharging system, a power failure detection circuit, a power converter or inverter, a power state indicator, and other components.

Although not shown in FIG. 4, the computer device 300 may also include a camera lens, a sensor, a wireless fidelity module, a Bluetooth module, etc., which will not be repeated herein.

The present disclosure further provides a robot on which a shooting apparatus and a sensor are mounted. The robot further includes a memory and a processor, where the memory stores a computer program, and when the processor executes the computer program, the steps in the above method embodiments are implemented.

The present disclosure further provides a computer-readable storage medium for storing a computer program. The computer-readable storage medium may be applied to a computer device, and the computer program causes the computer device to perform the corresponding process in the image processing method in the embodiments of the present disclosure. For brevity, details are not described herein again.

The present disclosure further provides a computer program product. The computer program product includes a computer program, and the computer program is stored in a computer-readable storage medium. A processor of a computer device reads the computer program from the computer-readable storage medium. The processor executes the computer program so that the computer device performs the corresponding process in the image processing method in the embodiments of the present disclosure. For brevity, details are not described herein again.

The present disclosure further provides a computer program. The computer program includes a computer program, and the computer program is stored in a computer-readable storage medium. A processor of a computer device reads the computer program from the computer-readable storage medium. The processor executes the computer program so that the computer device performs the corresponding process in the image processing method in the embodiments of the present disclosure. For brevity, details are not described herein again.

It should be understood that the processor in the embodiments of the present disclosure may be an integrated circuit chip with a signal processing capability. During implementation, the steps in the above method embodiments may be completed by an integrated logic circuit of hardware in the processor or an instruction in the form of software. The above processor may be a general-purpose processor, a digital signal processor (DSP), an application specific integrated circuit (ASIC), a field programmable gate array (FPGA), or other programmable logic devices, a discrete gate or transistor logic device, or a discrete hardware component. The methods, steps, and logic block diagrams disclosed in the embodiments of the present disclosure may be implemented or performed. The steps of the method disclosed in combination with the embodiments of the present disclosure may be directly embodied as being completed by a hardware decoding processor, or by a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in a memory. The processor reads information in the memory, and completes the steps in the above method in combination with the hardware of the processor.

It can be understood that the memory in this embodiment of the present disclosure may be a volatile memory or a non-volatile memory, or may include both the volatile memory and the non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of example but not restrictive description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memory for the system and method described herein is intended to include, but is not limited to, these and any other suitable types of memories.

Those of ordinary skill in the art may be aware that the modules and algorithm steps of various examples described in combination with the embodiments disclosed herein can be implemented in electronic hardware or a combination of computer software and electronic hardware. Whether these functions are performed in hardware or software depends on the specific application and design constraint conditions of the technical solution. Those skilled in the art can implement the described functions by using different methods for each particular application, but such implementation should not be considered as going beyond the scope of the present disclosure.

It can be clearly understood by those skilled in the art that, for convenience and brevity of description, for the specific operation processes of the system, apparatus, and units described above, reference may be made to the corresponding processes in the foregoing method embodiments, and details are not described herein again.

In the several embodiments provided in the present disclosure, it should be understood that the disclosed system, apparatus, and method may be implemented in other manners. For example, the apparatus embodiment described above is merely an example. For example, the unit division is merely logical function division and may be other division during actual implementation. For example, a plurality of units or components may be combined or integrated into another system, or some features may be omitted or not implemented. In addition, the displayed or discussed mutual couplings, direct couplings, or communication connections may be implemented through some interfaces. The indirect couplings or communication connections between the apparatuses or the units may be implemented in electrical, mechanical, or other forms.

The units described as separate parts may or may not be physically separate, and parts displayed as units may or may not be physical units, and may be located at one position, or may be distributed on a plurality of network units. Some or all of the units may be selected according to actual needs to achieve the objectives of the solutions of the embodiments.

In addition, various functional units in the embodiments of the present disclosure may be integrated into one processing unit, each of the units may exist alone physically, or two or more units may be integrated into one unit.

If the functions are implemented in the form of a software functional unit and sold or used as an independent product, the functions may be stored in a computer-readable storage medium. Based on such an understanding, the technical solutions of the present disclosure essentially, or the part that makes contributions, or some of the technical solutions may be embodied in the form of a software product. The computer software product is stored in a storage medium and includes several instructions for instructing a computer device (which may be a personal computer or a server) to perform all or some of the steps of the methods described in the embodiments of the present disclosure. Moreover, the foregoing storage medium includes: a USB flash disk, a mobile hard disk, an ROM, an RAM, a magnetic disk, an optical disc, or other various media that can store program code.

The foregoing descriptions are merely specific implementations of the present disclosure, but are not intended to limit the scope of protection of the present disclosure. Any variation or replacement readily figured out by those skilled in the art within the technical scope disclosed in the present disclosure shall fall within the scope of protection of the present disclosure. Therefore, the scope of protection of the present disclosure shall be subject to the scope of protection of the claims.

1. An image processing method, comprising:
obtaining observation information acquired by a target robot within a target observation space, wherein the observation information comprises observation images, depth images, and sensor pose information;
obtaining a three-dimensional semantic distribution map based on the observation information;
learning an exploration policy of the target robot based on conditions of a semantic distribution inconsistency and a class distribution uncertainty according to the three-dimensional semantic distribution map;
moving the target robot based on the exploration policy, to obtain an exploration trajectory of the target robot, wherein the exploration trajectory comprises target observation images acquired by the target robot during the movement within the target observation space;
obtaining, based on at least one condition of the semantic distribution inconsistency and the class distribution uncertainty, hard sample images from the target observation images corresponding to the exploration trajectory, wherein the hard sample images are used to represent images with inconsistent predicted semantic distribution results and/or uncertain predicted class distribution results; and
adjusting a perception model of the target robot based on the hard sample images.

2. The image processing method according to claim 1, wherein the semantic distribution inconsistency represents that inconsistent predicted distribution results are obtained by the target robot when observing a same target object at different viewing angles during the movement; and
the class distribution uncertainty represents a case where when observing a same target object at a same viewing angle during the movement of the target robot, the target robot predicts that there are a plurality of categories of the target object and two of the plurality of categories have similar predicted category probabilities and are both greater than a first preset threshold.

3. The image processing method according to claim 2, wherein the observation images comprise a first observation image and a second observation image, the first target observation image is an observation image acquired when the same target object is observed at different viewing angles, and the second target observation image is an observation image acquired when the same target object is observed at the same viewing angle; and
the learning an exploration policy of the target robot based on conditions of a semantic distribution inconsistency and a class distribution uncertainty according to the three-dimensional semantic distribution map comprises:
obtaining, based on the first observation image, a current prediction result of when the target robot observes the same target object at different viewing angles during the movement, and calculating a first semantic distribution inconsistency reward based on the current prediction result and the three-dimensional semantic distribution map;
obtaining first predicted category probabilities for all target objects in the second observation image, and calculating a first class distribution uncertainty reward based on the first predicted category probabilities for all the target objects; and
learning an exploration policy of the target robot based on the first semantic distribution inconsistency reward and the first class distribution uncertainty reward.

4. The image processing method according to claim 2, wherein the target observation images corresponding to the exploration trajectory comprise a first target observation image and a second target observation image, the first target observation image is an observation image acquired when the same target object is observed at different viewing angles, and the second target observation image is an observation image acquired when the same target object is observed at the same viewing angle; and
the obtaining, based on at least one condition of the semantic distribution inconsistency and the class distribution uncertainty, hard sample images from the target observation images corresponding to the exploration trajectory comprises:
obtaining, based on the condition of the semantic distribution inconsistency, a first hard sample image from the first target observation image corresponding to the exploration trajectory, wherein the first hard sample image is used to represent an image with an inconsistent predicted semantic distribution result; and/or
obtaining, based on the condition of the class distribution uncertainty, a second hard sample image from the second target observation image corresponding to the exploration trajectory, wherein the second hard sample image is used to represent an image with an uncertain predicted class distribution result.

5. The image processing method according to claim 4, wherein the obtaining, based on the condition of the class distribution uncertainty, a second hard sample image from the second target observation image corresponding to the exploration trajectory comprises:
obtaining a second target observation image corresponding to the exploration trajectory;
calculating second predicted category probabilities for all target objects in the second target observation image corresponding to the exploration trajectory;
calculating a second class distribution uncertainty based on the second predicted category probabilities for all the target objects in the second target observation image; and
determining, as a second hard sample image, a corresponding image in the second target observation image that has a second class distribution uncertainty greater than a first preset threshold.

6. The image processing method according to claim 4, wherein the obtaining, based on the condition of the semantic distribution inconsistency, a first hard sample image from the first target observation image corresponding to the exploration trajectory comprises:
obtaining a first target observation image corresponding to the exploration trajectory;
obtaining, based on the first target observation image, a target prediction result of when the target robot observes the same target object at different viewing angles during the movement, and calculating a second semantic distribution inconsistency based on the target prediction result and the three-dimensional semantic distribution map; and
determining, as a first hard sample image, a corresponding image in the first target observation image that has a second semantic distribution inconsistency greater than a second preset threshold.

7. The image processing method according to claim 1, wherein the moving the target robot based on the exploration policy, to obtain an exploration trajectory of the target robot comprises:
determining a direction of travel of the target robot at a next moment tᵢ₊₁ based on the exploration policy and target observation information acquired by the target robot at a current moment tᵢ, wherein the direction of travel is used to indicate a direction in which the target robot should move at the next moment tᵢ₊₁, the target observation information comprises target observation images, target depth images, and target sensor pose information, and i≥0; and
controlling the target robot to perform a movement operation based on the direction of travel, to obtain an exploration trajectory of the target robot and a target observation image at each time step on the exploration trajectory.

8. The image processing method according to claim 1, wherein the obtaining a three-dimensional semantic distribution map based on the observation information comprises:
inputting the observation images into a pre-trained perception model, to obtain semantic category prediction results for the observation images, wherein the semantic category prediction result is used to represent a predicted probability distribution of each pixel in the observation image among C categories, and C represents a predicted number of categories of target objects;
establishing a point cloud corresponding to the target observation space based on the depth images, wherein each point in the point cloud corresponds to a respective one of the semantic category prediction results;
transforming the point cloud into a three-dimensional space based on the sensor pose information, to obtain a voxel representation; and
aggregating, based on an exponential moving average formula, the voxel representation at a same position over time, to obtain the three-dimensional semantic distribution map.

9. The image processing method according to claim 8, wherein the adjusting a perception model of the target robot based on the hard sample images comprises:
obtaining the hard sample images and semantic annotation information for the hard sample images, wherein the semantic annotation information comprises bounding boxes for all target objects in each of the hard sample images, pixels corresponding to each of the target objects, and a category of each of the target objects;
inputting the hard sample images into the pre-trained perception model, to obtain semantic category prediction results corresponding to the hard sample images; and
adjusting parameters of the pre-trained perception model based on the semantic category prediction results corresponding to the hard sample images and the semantic annotation information, to obtain an adjusted perception model.

10. The image processing method according to claim 1, wherein before the learning an exploration policy of the target robot, the image processing method further comprises:
inputting the three-dimensional semantic distribution map into a global policy network to select a long-term objective, wherein the long-term objective represents x-y coordinates in the three-dimensional semantic distribution map;
inputting the long-term objective into a local policy network for path planning, to obtain a predicted discrete action of the target robot, wherein the predicted discrete action comprises at least one of moving forward, turning left, and turning left; and
sampling the long-term objective based on a preset number of local steps, to obtain sampled data, wherein the sampled data is used to learn the discrete action of the target robot.

11. The image processing method according to claim 1, wherein the obtaining observation information acquired by a target robot within a target observation space comprises:
obtaining, based on a shooting apparatus of the target robot, an observation image and a depth image corresponding to each time step within a preset time period, wherein the observation image is a color image, and the depth image is an image in which distance values of various points in the target observation space that are acquired by the shooting apparatus are used as pixel values; and
obtaining, based on a sensor of the target robot, sensor pose information corresponding to each time step within the preset time period, wherein the sensor pose information comprises at least pose information of three degrees of freedom.

12. (canceled)

13. A non-transient computer-readable storage medium storing a computer program, wherein the computer program is suitable for being loaded by a processor, to perform an image processing method, which comprises:
obtaining observation information acquired by a target robot within a target observation space, wherein the observation information comprises observation images, depth images, and sensor pose information;
obtaining a three-dimensional semantic distribution map based on the observation information;
learning an exploration policy of the target robot based on conditions of a semantic distribution inconsistency and a class distribution uncertainty according to the three-dimensional semantic distribution map;
moving the target robot based on the exploration policy, to obtain an exploration trajectory of the target robot, wherein the exploration trajectory comprises target observation images acquired by the target robot during the movement within the target observation space;
obtaining, based on at least one condition of the semantic distribution inconsistency and the class distribution uncertainty, hard sample images from the target observation images corresponding to the exploration trajectory, wherein the hard sample images are used to represent images with inconsistent predicted semantic distribution results and/or uncertain predicted class distribution results; and
adjusting a perception model of the target robot based on the hard sample images.

14. A computer device, comprising at least one processor and at least one memory, wherein the at least one memory stores a computer program, and the at least one processor is configured to perform an image processing method by invoking the computer program stored in the at least one memory, and the method comprises:
obtaining observation information acquired by a target robot within a target observation space, wherein the observation information comprises observation images, depth images, and sensor pose information;
obtaining a three-dimensional semantic distribution map based on the observation information;
learning an exploration policy of the target robot based on conditions of a semantic distribution inconsistency and a class distribution uncertainty according to the three-dimensional semantic distribution map;
moving the target robot based on the exploration policy, to obtain an exploration trajectory of the target robot, wherein the exploration trajectory comprises target observation images acquired by the target robot during the movement within the target observation space;
obtaining, based on at least one condition of the semantic distribution inconsistency and the class distribution uncertainty, hard sample images from the target observation images corresponding to the exploration trajectory, wherein the hard sample images are used to represent images with inconsistent predicted semantic distribution results and/or uncertain predicted class distribution results; and
adjusting a perception model of the target robot based on the hard sample images.

15. (canceled)

16. The image processing method according to claim 3, wherein the target observation images corresponding to the exploration trajectory comprise a first target observation image and a second target observation image, the first target observation image is an observation image acquired when the same target object is observed at different viewing angles, and the second target observation image is an observation image acquired when the same target object is observed at the same viewing angle; and
the obtaining, based on at least one condition of the semantic distribution inconsistency and the class distribution uncertainty, hard sample images from the target observation images corresponding to the exploration trajectory comprises:
obtaining, based on the condition of the semantic distribution inconsistency, a first hard sample image from the first target observation image corresponding to the exploration trajectory, wherein the first hard sample image is used to represent an image with an inconsistent predicted semantic distribution result; and/or
obtaining, based on the condition of the class distribution uncertainty, a second hard sample image from the second target observation image corresponding to the exploration trajectory, wherein the second hard sample image is used to represent an image with an uncertain predicted class distribution result.

17. The image processing method according to claim 5, wherein the obtaining, based on the condition of the semantic distribution inconsistency, a first hard sample image from the first target observation image corresponding to the exploration trajectory comprises:
obtaining a first target observation image corresponding to the exploration trajectory;
obtaining, based on the first target observation image, a target prediction result of when the target robot observes the same target object at different viewing angles during the movement, and calculating a second semantic distribution inconsistency based on the target prediction result and the three-dimensional semantic distribution map; and
determining, as a first hard sample image, a corresponding image in the first target observation image that has a second semantic distribution inconsistency greater than a second preset threshold.

18. The image processing method according to claim 2, wherein the moving the target robot based on the exploration policy, to obtain an exploration trajectory of the target robot comprises:
determining a direction of travel of the target robot at a next moment tᵢ₊₁ based on the exploration policy and target observation information acquired by the target robot at a current moment tᵢ, wherein the direction of travel is used to indicate a direction in which the target robot should move at the next moment tᵢ₊₁, the target observation information comprises target observation images, target depth images, and target sensor pose information, and i≥0; and
controlling the target robot to perform a movement operation based on the direction of travel, to obtain an exploration trajectory of the target robot and a target observation image at each time step on the exploration trajectory.

19. The image processing method according to claim 3, wherein the moving the target robot based on the exploration policy, to obtain an exploration trajectory of the target robot comprises:
determining a direction of travel of the target robot at a next moment tᵢ₊₁ based on the exploration policy and target observation information acquired by the target robot at a current moment tᵢ, wherein the direction of travel is used to indicate a direction in which the target robot should move at the next moment tᵢ₊₁, the target observation information comprises target observation images, target depth images, and target sensor pose information, and i≥0; and
controlling the target robot to perform a movement operation based on the direction of travel, to obtain an exploration trajectory of the target robot and a target observation image at each time step on the exploration trajectory.

20. The image processing method according to claim 4, wherein the moving the target robot based on the exploration policy, to obtain an exploration trajectory of the target robot comprises:
determining a direction of travel of the target robot at a next moment tᵢ₊₁ based on the exploration policy and target observation information acquired by the target robot at a current moment tᵢ, wherein the direction of travel is used to indicate a direction in which the target robot should move at the next moment tᵢ₊₁, the target observation information comprises target observation images, target depth images, and target sensor pose information, and i≥0; and
controlling the target robot to perform a movement operation based on the direction of travel, to obtain an exploration trajectory of the target robot and a target observation image at each time step on the exploration trajectory.

21. The image processing method according to claim 5, wherein the moving the target robot based on the exploration policy, to obtain an exploration trajectory of the target robot comprises:
determining a direction of travel of the target robot at a next moment tᵢ₊₁ based on the exploration policy and target observation information acquired by the target robot at a current moment tᵢ, wherein the direction of travel is used to indicate a direction in which the target robot should move at the next moment tᵢ₊₁, the target observation information comprises target observation images, target depth images, and target sensor pose information, and i≥0; and
controlling the target robot to perform a movement operation based on the direction of travel, to obtain an exploration trajectory of the target robot and a target observation image at each time step on the exploration trajectory.

22. The image processing method according to claim 6, wherein the moving the target robot based on the exploration policy, to obtain an exploration trajectory of the target robot comprises:
determining a direction of travel of the target robot at a next moment tᵢ₊₁ based on the exploration policy and target observation information acquired by the target robot at a current moment tᵢ, wherein the direction of travel is used to indicate a direction in which the target robot should move at the next moment tᵢ₊₁, the target observation information comprises target observation images, target depth images, and target sensor pose information, and i≥0; and
controlling the target robot to perform a movement operation based on the direction of travel, to obtain an exploration trajectory of the target robot and a target observation image at each time step on the exploration trajectory.
